(19) United States
(12) Patent Application Publication
(10) Pub. No.: US 2025/0274348 A1
(43) Pub. Date: Aug. 28, 2025

(54) METHOD AND APPARATUS FOR SUPPORTING SERVICE CONTINUITY FOR UE MOVING BETWEEN MOBILE COMMUNICATION NETWORKS

(71) Applicant: ELECTRONICS AND TELECOMMUNICATIONS RESEARCH INSTITUTE, Daejeon (KR)

(72) Inventors: Jihoon SUNG, Daejeon (KR); Soohwan LEE, Daejeon (KR); Myung Ki SHIN, Daejeon (KR)

(73) Assignee: ELECTRONICS AND TELECOMMUNICATIONS RESEARCH INSTITUTE, Daejeon (KR)

(21) Appl. No.: 18/554,138

(22) PCT Filed: Apr. 6, 2022
(86) PCT No.: PCT/KR2022/004986

§ 371 Date: May 1, 2024

(30) Foreign Application Priority Data
Apr. 6, 2021 (KR) 10-2021-0044847
Apr. 6, 2022 (KR) 10-2022-0043044

(51) Int. Cl. H04L 41/14; H04W 36/14; H04W 84/04

(52) U.S. Cl. CPC H04L 41/14; H04W 36/144; H04W 84/042

(57) ABSTRACT

Provided is a method for supporting service continuity for UE, moving between a PLMN and an SNPN, by means of the steps of: receiving analysis information relating to UE, which is configured with a PDU session with an SNPN, from the NWDAF of a PLMN by means of non-3GPP access; determining that the UE will move from the PLMN to the SNPN on the basis of the analysis information; and instructing the UE to change the access for the SNPN PDU session from non-3GPP access to 3GPP access, on the basis of the determination.

### TECHNICAL FIELD

The following description relates to a method and apparatus for supporting service continuity for user equipment (UE) moving between a stand-alone non-public network (SNPN) and a public land mobile network (PLMN) using a fifth generation (5G) network data analytics function (NWDAF).

### BACKGROUND ART

There may be a need for supporting seamless service continuity of the 3rd generation partnership project (3GPP) access when user equipment (UE) moves between a public network and a non-public network.

### DISCLOSURE OF INVENTION

### Technical Goals

An aspect provides a method of supporting service continuity when user equipment (UE) moves from a stand-alone non-public network (SNPN) to a public land mobile network (PLMN).

Another aspect provides a method of supporting service continuity when UE moves from a PLMN to an SNPN.

### Technical Solutions

According to an embodiment, there is provided a method of supporting service continuity of user equipment (UE) moving from a stand-alone non-public network (SNPN) to a public land mobile network (PLMN), the method including: receiving, from a 5G network data analytics function (NWDAF) of the SNPN, analysis information about UE that has established a PLMN protocol data unit (PDU) session with the PLMN using non-3GPP access; determining that the UE is to move from the SNPN to the PLMN based on the analysis information; and instructing the UE to change access for the PLMN PDU session from the non-3GPP access to 3GPP access based on the determining.

The determining that the UE is to move from the SNPN to the PLMN based on the analysis information may include: predicting that the UE is to move from the SNPN to the PLMN based on the analysis information before the UE departs from a coverage of the SNPN.

The determining that the UE is to move from the SNPN to the PLMN based on the analysis information may include: predicting that the UE is to move from the SNPN to the PLMN based on the analysis information before the UE recognizes a coverage loss from the SNPN.

The analysis information may include UE mobility predictions related to mobility of the UE and/or UE mobility statistics related to the mobility of the UE.

The instructing the UE to change access for the PLMN PDU session from the non-3GPP access to the 3GPP access based on the determining may include: instructing the UE on a handover from the SNPN to the PLMN based on the determining.

The instructing the UE to change access for the PLMN PDU session from the non-3GPP access to the 3GPP access based on the determining may include: instructing the UE to switch a user plane resource for the PLMN PDU session from the non-3GPP access to the 3GPP access based on the determining.

The receiving the analysis information about the UE that has established the PLMN PDU session with the PLMN using the non-3GPP access from the NWDAF of the SNPN may include: transmitting a request for the analysis information to a network exposure function (NEF) of the SNPN through an application function (AF) of the PLMN.

Before the receiving the analysis information about the UE that has established the PLMN PDU session with the PLMN using the non-3GPP access from the NWDAF of the SNPN, an SNPN PDU session using the 3GPP access may be established between the UE and the SNPN, and the PLMN PDU session using the non-3GPP access may be established between the UE and the PLMN.

According to another embodiment, there is provided a method of supporting service continuity of UE moving from a PLMN to an SNPN, the method including: receiving, from an NWDAF of the PLMN, analysis information about UE that has established an SNPN PDU session with the SNPN using non-3GPP access; determining that the UE is to move from the PLMN to the SNPN based on the analysis information; and instructing the UE to change access for the SNPN PDU session from the non-3GPP access to 3GPP access based on the determining.

The determining that the UE is to move from the PLMN to the SNPN based on the analysis information may include: predicting that the UE is to move from the PLMN to the SNPN based on the analysis information before the UE departs from a coverage of the PLMN.

The determining that the UE is to move from the PLMN to the SNPN based on the analysis information may include: predicting that the UE is to move from the PLMN to the SNPN based on the analysis information before the UE recognizes a coverage loss from the PLMN.

The analysis information may include UE mobility predictions related to mobility of the UE and/or UE mobility statistics related to the mobility of the UE.

The instructing the UE to change access for the SNPN PDU session from the non-3GPP access to the 3GPP access based on the determining may include: instructing the UE on a handover from the PLMN to the SNPN based on the determining.

The instructing the UE to change access for the SNPN PDU session from the non-3GPP access to the 3GPP access based on the determining may include: instructing the UE to switch a user plane resource for the SNPN PDU session from the non-3GPP access to the 3GPP access based on the determining.

The receiving the analysis information about the UE that has established the SNPN PDU session with the SNPN from the NWDAF of the PLMN using the non-3GPP access may include: transmitting a request for the analysis information to an NEF of the PLMN through an AF of the SNPN.

Before receiving the analysis information about the UE that has established the SNPN PDU session with the SNPN using the non-3GPP access from the NWDAF of the PLMN, a PLMN PDU session using the 3GPP access may be established between the UE and the PLMN, and the SNPN PDU session using the non-3GPP access may be established between the UE and the SNPN.

### Effects of Invention

Service continuity may be provided to user equipment (UE) moving between a public network and a non-public network without interruption in the 3rd generation partnership project (3GPP) access.

### BRIEF DESCRIPTION OF DRAWINGS

FIG. 1 is a conceptual diagram illustrating a wireless communication system according to an embodiment.

FIGS. 2 and 3 are block diagrams illustrating a wireless communication system according to an embodiment.

FIG. 4 is a conceptual diagram illustrating two scenarios in which user equipment (UE) moves from a stand-alone non-public network (SNPN) to a public land mobile network (PLMN) according to an embodiment.

FIG. 5 is a flowchart illustrating a method of supporting service continuity when UE moves from an SNPN to a PLMN according to an embodiment.

FIG. 6 is a flowchart illustrating a method of supporting service continuity when UE moves from an SNPN to a PLMN according to another embodiment.

FIG. 7 is a conceptual diagram illustrating a scenario in which UE moves from a PLMN to an SNPN according to an embodiment.

FIG. 8 is a flowchart illustrating a method of supporting service continuity when UE moves from a PLMN to an SNPN according to an embodiment.

FIG. 9 is a flowchart illustrating a method of supporting service continuity when UE moves from a PLMN to an SNPN according to another embodiment.

FIG. 10 is a block diagram illustrating a wireless communication system according to an embodiment.

### BEST MODE FOR CARRYING OUT INVENTION

Hereinafter, various embodiments of the present disclosure will be described in detail with reference to the accompanying drawings so that those skilled in the art can easily implement the embodiments of the present disclosure. However, the present disclosure may be implemented in various different forms and is not limited to the embodiments described herein. For clear description, irrelevant parts in the drawings are omitted from the description, and when describing the embodiments with reference to the accompanying drawings, like reference numerals refer to like components and a repeated description related thereto will be omitted.

Throughout the specification, user equipment (UE) refers to a terminal, a mobile station (MS), a mobile terminal (MT), an advanced mobile station (AMS), a high-reliability mobile station (HR-MS), a subscriber station (SS), a portable subscriber station (PSS), an access terminal (AT), a machine-type communication (MTC) device, or the like, and may include all or part of the functions of the UE, the MS, the MT, the AMS, the HR-MS, the SS, the PSS, the AT, or the like.

In addition, a radio access network (RAN) may refer to a base station (BS), a node B, an evolved node B (eNB), gNB, an advanced base station (ABS), a high-reliability base station (HR-BS), an access point (AP), a radio access station (RAS), a base transceiver station (BTS), a mobile multihop relay (MMR)-BS, a relay station (RS) performing the role of a BS, a relay node (RN) performing the role of a BS, an advanced relay station (ARS) performing the role of a BS, a high-reliability relay station (HR-RS) performing the role of a BS, a small BS (or femto BS), a home node B (HNB), a home eNodeB (HeNB), a pico BS, a macro BS, a micro BS, or the like, and may include functions of all or some of the NB, the eNB, the gNB, the ABS, the AP, the RAS, the BTS, the MMR-BS, the RS, the RN, the ARS, the HR-RS, small BS, or the like.

The singular forms “a,” “an,” and “the” are intended to include the plural forms as well, unless the context clearly indicates otherwise with specific terms such as “one” or “single.”

A wireless communication system described herein according to an embodiment may be applied to various wireless communication networks. The wireless communication system may be applied to, for example, a current radio access technology (RAT)-based wireless communication network or a 5G or later wireless communication network. The 3rd Generation Partnership Project (3GPP) is developing a new RAT-based 5G standard that satisfies International Mobile Telecommunications-2020 (IMT-2020 standard) requirements, and this new RAT is referred to as new radio (NR). Although an NR-based wireless communication system is provided herein as an example for the convenience of description, embodiments described herein are not limited thereto but may be applied to various wireless communication systems.

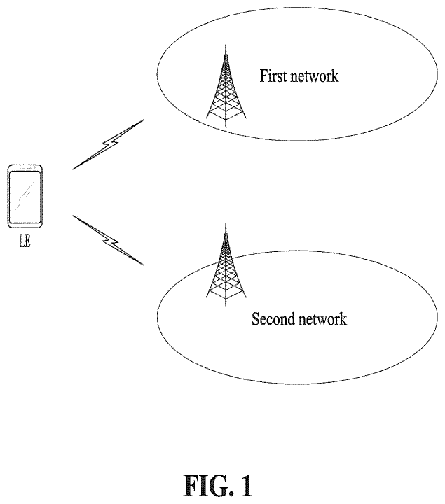

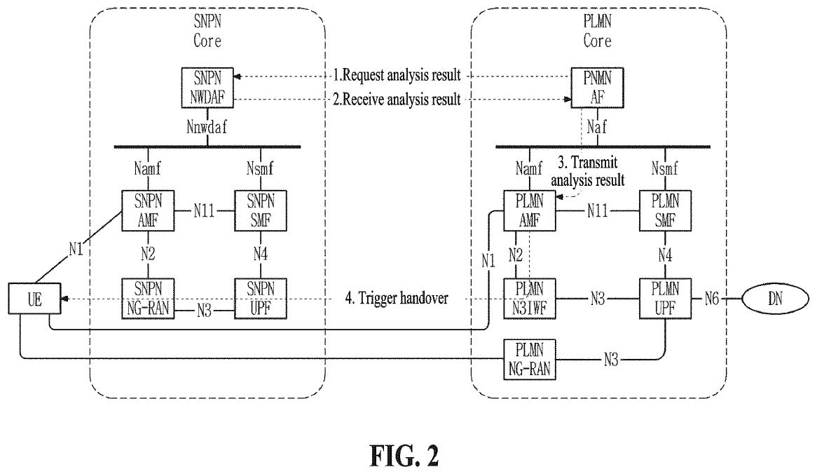

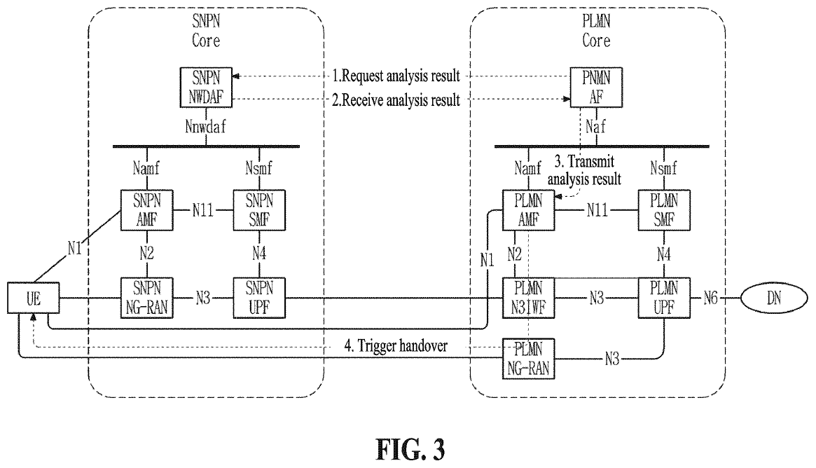

FIG. 1 is a conceptual diagram illustrating a wireless communication system according to an embodiment. FIGS. 2 and 3 are block diagrams illustrating a wireless communication system according to an embodiment.

30 Referring to FIG. 1, UE may be connected to both a first network and a second network and may move between the first network and the second network. In this case, the first network may be a public land mobile network (PLMN) or a non-public network (NPN), and the second network may be a PLMN or an NPN. Throughout the specification, the NPN may be a stand-alone NPN (SNPN), which may be provided herein only as an example.

In an embodiment, a network having connectivity with the UE may change from a PLMN (e.g., the first network) to an NPN (e.g., the second network). Alternatively, the network having connectivity with the UE may change from an NPN (e.g., the first network) to a PLMN (e.g., the second network). Alternatively, the network having connectivity with the UE may change from a first NPN (e.g., the first network) to a second NPN (an NPN different from the first NPN, or the second network). When the network having connectivity with the UE is changed, the continuity of a service provided to the UE may need to be maintained/guaranteed.

In an embodiment, in a case in which, after recognizing that a currently connected network has been disconnected, the UE belatedly performs a handover or triggers user plane switching, service disconnection may be unavoidable. In addition, a network, which may be an entity triggering the handover or user plane switching, for example, a network to which the UE is to move, may not easily detect a coverage loss in the network currently connected to the UE. For example, a section from a network function of the network to which the UE is to move to the UE, i.e., a UE-to-N3IWF section (in the network to which the UE is to move), may be tunneled, and thus an event (e.g., coverage loss) occurring within the corresponding tunnel may be difficult to be detected by the network to which the UE is to move.

In an embodiment, user plane switching may refer to switching a user plane resource for a protocol data unit (PDU) session from non-3GPP access to 3GPP access. For example, user plane switching for a PDU session may be adding or activating a user plane resource used for 3GPP access and releasing or deactivating a user plane resource used for non-3GPP access. The terms “user plane switching” and “activating or deactivating a user plane resource” may be used to indicate the same. In this case, switching a resource to be activated may be used to indicate “user plane switching.” When switching a user plane resource is instructed, the user plane resource for specific access (e.g., non-3GPP access) may be deactivated while the user plane resource for another specific access (e.g., 3GPP access) may be activated.

Referring to FIGS. 2 and 3, when UE connected to an SNPN through 3GPP access attempts to move to a PLMN, the PLMN may request a 5G network data analytics function (NWDAF) of the SNPN for analysis information (or analytics information) associated with the mobility of the UE (e.g., UE mobility predictions or UE mobility statistics) through an application function (AF) of the PLMN.

Subsequently, the analysis information about the mobility (or location) of the UE generated by the NWDAF of the SNPN may be transmitted to an access and mobility management function (AMF) of the PLMN through the AF of the PLMN, and the AMF of the PLMN may instruct the UE on a handover or user plane switching through an N3IWF of the PLMN or a next-generation radio access network (NG-RAN) of the PLMN. In an embodiment, the analysis information about the mobility of the UE transmitted to the AF of the PLMN may be transmitted to the AMF of the PLMN through an NF such as a policy control function (PCF) and/or session management function (SMF) of the PLMN.

According to an embodiment, the UE may preliminarily activate non-3GPP access in advance for the handover or the user plane switching to the PLMN. In this case, after establishing a PDU session with the SNPN (or an SNPN PDU session) using 3GPP access, the UE may 1) preliminarily activate non-3GPP access, 2) dynamically activate non-3GPP access at the discretion of the UE, or 3) activate non-3GPP access at the discretion of an AMF of the SNPN.

According to an embodiment, the UE may establish the SNPN PDU session using 3GPP access and preliminarily activate non-3GPP access. That is, after being connected to the SNPN using 3GPP access, the UE may activate non-3GPP access and establish a PDU session with the PLMN (or a PLMN PDU session) using the activated non-3GPP access. Thus, service continuity may be supported for the UE that moves from the SNPN to the PLMN. In an embodiment, non-3GPP access may be a representation of logical access to an interworking function of a core network (e.g., non-3GPP interworking function (N3IWF)). For example, non-3GPP access may not be physical access such as Wi-Fi but logical access for the UE to be connected to the interworking function of the core network.

After establishing the SNPN PDU session using 3GPP access, the UE may determine whether non-3GPP access needs to be activated based on parameters (e.g., reference signal received power (RSRP), reference signal received quality (RSRQ), or the like) related to a wireless environment with the RAN of the SNPN. For example, when determining that the wireless environment with the RAN of the SNPN is poor or undesirable, the UE may activate non-3GPP access for connection to the PLMN and establish the PLMN PDU session using the activated non-3GPP access.

Alternatively, after the UE establishes the SNPN PDU session using 3GPP access, the AMF of the SNPN may instruct the UE to activate non-3GPP access based on UE analysis information (or UE analytics) of the UE generated by the NWDAF of the SNPN. In this case, the AMF may determine UE for which non-3GPP access is to be activated, using the analysis information associated with the mobility of the UE (e.g., UE mobility predictions and/or UE mobility statistics) from the NWDAF of the SNPN, and may instruct the UE that is predicted to move from the SNPN to the PLMN to activate non-3GPP access. The AMF of the SNPN may determine UE from which a movement to the PLMN is to be monitored, based on a movement history of the UE. Alternatively, the AMF of the SNPN may perform monitoring (i.e., monitoring a movement to the PLMN) UEs located at a cell border, UEs near the PLMN, and UEs in a TA near the PLMN.

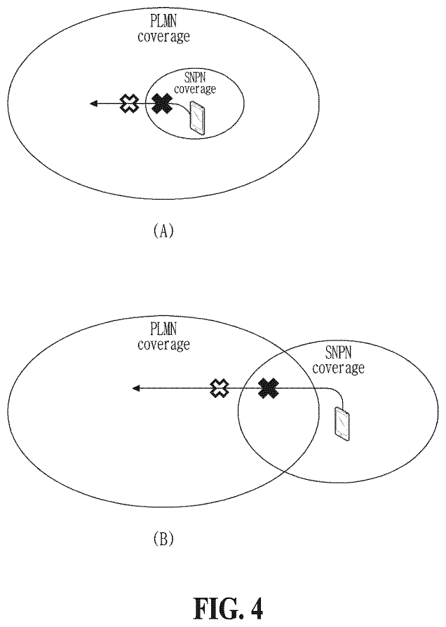

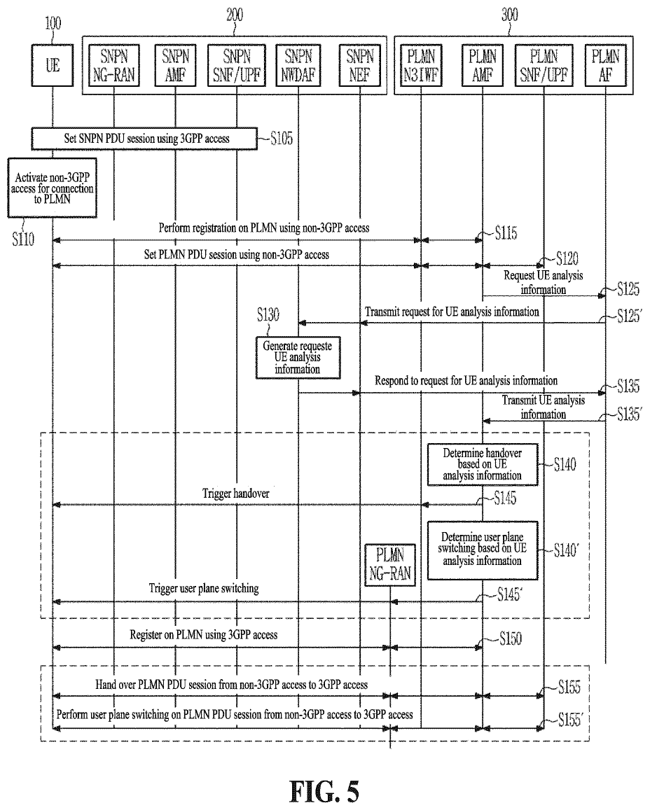

FIG. 4 is a conceptual diagram illustrating two scenarios in which UE moves from an SNPN to a PLMN, and FIG. 5 is a flowchart illustrating a method of supporting service continuity when UE moves from an SNPN to a PLMN according to an embodiment.

According to an embodiment, UE 100 may receive a service from an SNPN 200 using 3GPP access and simultaneously receive a service from a PLMN 300 through logical non-3GPP access, during which, it may hand over the 3GPP access to the PLMN 300 (i.e., single radio) or may connect to the PLMN 300 through separate 3GPP access (i.e., dual radio).

Referring to FIG. 4, the coverage of the PLMN 300 may include the coverage of the SNPN 200 as shown in (A), or the coverage of the PLMN 300 and the coverage of the SNPN 200 may form an overlapping area as shown in (B). In an embodiment, the UE 100, which has had 3GPP access to the SNPN 200, may perform the handover or the user plane switching from the SNPN 200 to the PLMN 300 according to an instruction of an AMF of the SNPN 200 or an AMF of the PLMN 300 before departing from the coverage of the SNPN 200. The AMF of the PLMN 300 may transmit a trigger for the handover or the user plane switching to the UE 100 based on UE analysis information generated by an NWDAF of the SNPN 200.

Referring to FIG. 5, the UE 100 may establish a PDU session with the SNPN 200 (i.e., an SNPN PDU session) using 3GPP access in step S105. Subsequently, the UE 100 may activate non-3GPP access for connection to the PLMN 300 in step S110. The UE 100 may activate non-3GPP access to connect to the PLMN 300 according to a determination of the UE 100 itself or an instruction from another entity (e.g., the AMF of the SNPN 200, etc.).

The AMF of the SNPN 200 may generate activation signaling using a location of the UE 100, a network deployment, a service-level agreement (SLA), or the like, and instruct the UE 100 to activate non-3GPP access using the activation signaling. The activation signaling may include action information of the UE 100 for the connection to the PLMN 300, and the action information may include parameters related to registration, PDU session establishment, a target network identifier, an access type, a session and service continuity (SSC) mode, and an area where the UE 100 is located (e.g., an applicable area for UE action).

The UE 100 that has activated non-3GPP access may perform the registration on the PLMN 300 through an N3IWF of the PLMN 300 using non-3GPP access in step S115. The UE 100 may determine whether to perform the registration on the PLMN 300 using the activation signaling and related information (e.g., subscription information of the UE 100, location information of the UE 100, PLMN N3IWF address, etc.). Subsequently, the UE 100 may establish a PDU session with the PLMN 300 (i.e., a PLMN PDU session) through the N3IWF of the PLMN 300 using non-3GPP access in step S120.

When the UE 100 performs the registration on the PLMN 300 and/or establishes the PLMN PDU session, the AMF of the PLMN 300 may request the NWDAF of the SNPN 200 for UE analysis information (or UE analytics information) of the UE 100 to trigger the handover (single radio) or the user plane switching (dual radio) of the UE 100 in step S125. The NWDAF of the SNPN 200 may identify a UE for which generation of UE analysis information is requested from the request for the UE analysis information and generate UE analysis information of the identified UE in step S130. Subsequently, the NWDAF of the SNPN 200 may transmit the generated UE analysis information to the AMF of the PLMN 300 in step S135.

When there is a UE registered on the PLMN 300 through non-3GPP access or when there is a UE that has established the PLMN PDU session through non-3GPP access, the AMF of the PLMN 300 may request the NWDAF of the SNPN 200 for UE analysis information of the UE. The AMF of the PLMN 300 may request the NWDAF of the SNPN 200 for the UE analysis information, using an identifier of the UE that has established the PLMN PDU session, for example, a generic public subscription identifier (GPSI), a subscription permanent identifier (SUPI), a subscription concealed identifier (SUCI), an international mobile subscriber identity (IMSI), an international mobile equipment identity (IMEI), or the like.

The UE analysis information may include at least one of UE mobility analytics, UE communication analytics, UE location-related prediction information/statistic information, or UE mobility predictions/UE mobility statistics. The UE location/mobility-related prediction information may be, for example, UE location information of the UE 100 associated with a location where the UE 100 is expected to be present after several time durations or time slots in the future, for example, a cell identifier, a tracking area identifier (TAI), a tracking area code (TAC), or the like.

The request for the UE analysis information transmitted by the AMF of the PLMN 300 may be relayed by an AF of the PLMN 300 and a network exposure function (NEF) of the SNPN 200. For example, the AF of the PLMN 300 may transmit the request for the UE analysis information about the UE 100 to the NEF of the SNPN 200 that is connected to the UE 100 through 3GPP access.

The NEF of the SNPN 200 may receive the UE analysis information from the NWDAF of the SNPN 200 and transmit the UE analysis information to the AF of the

PLMN 300. After receiving the UE analysis information from the AF of the PLMN 300, the AMF of the PLMN 300 may determine the handover of the UE 100 in step S140 or the user plane switching in step S140′, based on the UE analysis information generated by the NWDAF of the SNPN 200. In an embodiment, a PCF or the like of the PLMN 300 may change an access and mobility (AM) policy of a terminal based on the UE analysis information transmitted from the AF of the PLMN 300, and the AMF of the PLMN 300 may determine the handover of the UE 100 or the user plane switching according to the changed AM policy.

The AMF of the PLMN 300 may predict that the UE 100 is to move from the SNPN 200 to the PLMN 300 based on the analysis information before the UE 100 departs from the coverage of the SNPN 200 and may determine the handover or the user plane switching of the UE 100 according to this prediction. Alternatively, the AMF of the PLMN 300 may predict that the UE 100 is to move from the SNPN 200 to the PLMN 300 based on the analysis information before the UE 100 recognizes a coverage loss from the SNPN 200 and may determine the handover or the user plane switching of the UE 100 based on this prediction.

In the case of single radio, after the AMF of the PLMN 300 determines the handover of the UE 100 based on the UE analysis information, the handover of the UE 100 may be triggered through the N3IWF of the PLMN 300 in step S145. Subsequently, the UE 100 may perform the handover from the SNPN 200 to the PLMN 300. For example, when the UE 100 is in a PLMN coverage, the UE 100 may register with the PLMN 300 using 3GPP access in step S150 and may change a wireless system in the PLMN PDU session from non-3GPP access to 3GPP access in step S155. By the handover in step S155, the SNPN PDU session between the UE 100 and the SNPN 200 in the single radio case may be terminated, and the PLMN PDU session between the UE 100 and the PLMN 300 may continue through 3GPP access.

In an embodiment, the SNPN PDU session between the UE 100 and the SNPN 200 may be temporarily terminated. If necessary, the UE 100 or the SNPN 200 may establish the SNPN PDU session using logical non-3GPP access to immediately establish (or restore) the SNPN PDU session. In addition, in a similar way of establishing the PLMN PDU session with the PLMN 300 using the logical non-3GPP access when UE moves from the SNPN 200 to the PLMN 300, and the UE 100 may, on the contrary, establish the SNPN PDU session with the SNPN 200 using the same method described above in a situation where the UE 100 is handed over to the PLMN 300.

In the case of dual radio, after determining the user plane switching of the UE 100 based on the UE analysis information, the AMF of the PLMN 300 may trigger the user plane switching for the UE 100 through an NG-RAN of the PLMN 300 in step S145′. Subsequently, the UE 100 may perform the user plane switching from the SNPN 200 to the PLMN 300. For example, the UE 100 may register with the PLMN 300 using 3GPP access in step S150 and perform the user plane switching on the PLMN PDU session from non-3GPP access to 3GPP access in step S155′. By the user plane switching in step S155′, the PLMN PDU session between the UE 100 and the PLMN 300 in the dual radio case may continue through 3GPP access. In addition, in the dual radio case, the PLMN PDU session between the UE 100 and the PLMN 300 may also continue by session establishment through logical non-3GPP access. In this case, the SNPN PDU session between the UE 100 and the SNPN 200 may not be terminated. In an embodiment, when the connection between the UE 100 and the PLMN 300 is maintained, the SNPN PDU session between the UE 100 and the SNPN 200 may not be terminated using logical non-3GPP access.

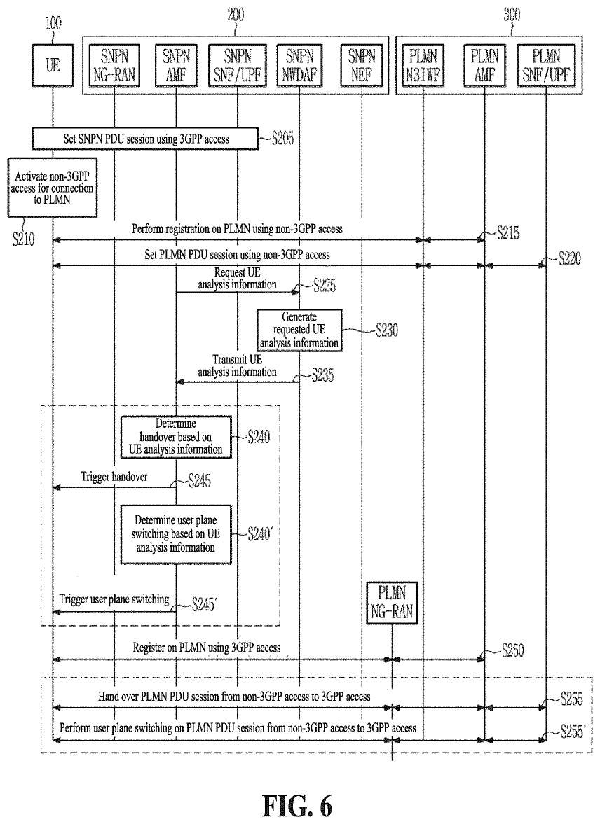

FIG. 6 is a flowchart illustrating a method of supporting service continuity when UE moves from an SNPN to a PLMN according to another embodiment.

In an embodiment, the UE 100, which has had 3GPP access to the SNPN 200, may perform the handover or the user plane switching from the SNPN 200 to the PLMN 300 according to an instruction of the AMF of the SNPN 200 before departing from the coverage of the SNPN 200. The AMF of the SNPN 200 may transmit a trigger for the handover or the user plane switching to the UE 100 based on the UE analysis information generated by the NWDAF of the SNPN 200.

Referring to FIG. 6, the UE 100 may establish a PDU session with the SNPN 200 (i.e., an SNPN PDU session) using 3GPP access in step S205. Subsequently, the UE 100 may activate non-3GPP access for connection to the PLMN 300 in step S210. The UE 100 may activate non-3GPP access to connect to the PLMN 300 according to a determination of the UE 100 itself or an instruction from another entity (e.g., the AMF of the SNPN 200, etc.).

The AMF of the SNPN 200 may generate activation signaling using a location of the UE 100, a network deployment, an SLA, or the like, and instruct the UE 100 to activate non-3GPP access using the activation signaling. The activation signaling may include action information of the UE 100 for the connection to the PLMN 300, and the action information may include parameters related to registration, PDU session establishment, a target network identifier, an access type, an SSC mode, and an area where the UE 100 is located (e.g., an applicable area for UE action).

The UE 100 that has activated non-3GPP access may perform registration on the PLMN 300 through the N3IWF of the PLMN 300 using non-3GPP access in step S215. Before performing the registration, the UE 100 may determine whether to register with the PLMN 300 using the activation signaling and related information (e.g., subscription information of the UE 100, location information of the UE 100, a PLMN N3IWF address, etc.). Subsequently, the UE 100 may establish a PLMN PDU session with the PLMN 300 through the N3IWF of the PLMN 300 using non-3GPP access in step S220.

When the UE 100 activates non-3GPP access for the connection to the PLMN 300, the AMF of the SNPN 200 may request the NWDAF of the SNPN 200 for UE analysis information of the UE 100 to trigger a handover of the UE 100 (single radio) or user plane switching (dual radio) in step S225. The UE analysis information requested by the AMF of the SNPN 200 may be generated by the NWDAF of the SNPN 200 in step S230 and may then be transmitted to the AMF of the SNPN 200 in step S235.

The SNPN 200 may request the NWDAF of the SNPN 200 for the UE analysis information, using an identifier of a UE that has activated non-3GPP access, for example, a GPSI, a SUPI, a SUCI, an IMSI, an IMEI, a globally unique temporary identifier (GUTI), or the like.

The UE analysis information may include at least one of UE mobility analytics, UE communication analytics, UE location-related prediction information/statistic information, or UE mobility predictions/statistics. The UE location/mobility-related prediction information may be, for example, UE location information (e.g., a cell identifier, a TAI, a TAC, etc.) of the UE 100 associated with a location where the UE 100 is expected to be present after several time durations or time slots in the future.

Based on the UE analysis information generated by the NWDAF of the SNPN 200, the AMF of the SNPN 200 may determine the handover of the UE 100 in step S240 or determine the user plane switching in step S240′. The AMF of the SNPN 200 may predict that the UE 100 is to move from the SNPN 200 to the PLMN 300 based on the analysis information before the UE 100 departs from the coverage of the SNPN 200 and may then determine the handover of the UE 100 or the user plane switching based on the prediction. Alternatively, the AMF of the SNPN 200 may predict that the UE 100 is to move from the SNPN 200 to the PLMN 300 based on the analysis information before the UE 100 recognizes a coverage loss from the SNPN 200 and may then determine the handover of the UE 100 or the user plane switching based on the prediction.

In an embodiment, a PCF or the like of the SNPN 200 may change an AM policy of a terminal based on the UE analysis information transmitted from the NWDAF of the SNPN 200, and the AMF of the SNPN 200 may determine the handover or the user plane switching of the UE 100 according to the changed AM policy.

In the case of single radio, after the AMF of the SNPN 200 determines the handover of the UE 100 based on the UE analysis information, the handover may be triggered for the UE 100 through the RAN of the SNPN 200 in step S245.

Subsequently, the UE 100 may perform the handover from the SNPN 200 to the PLMN 300. For example, the UE 100 may register with the PLMN 300 using 3GPP access in step S250 and change a wireless system of the PLMN PDU session from non-3GPP access to 3GPP access in step S255. By the handover in step S255, the SNPN PDU session between the UE 100 and the SNPN 200 in the single radio case may be terminated, and the PLMN PDU session between the UE 100 and the PLMN 300 may continue through 3GPP access.

In an embodiment, the SNPN PDU session between UE 100 and the SNPN 200 may be temporarily terminated. If necessary, the UE 100 or the SNPN 200 may establish the SNPN PDU session using logical non-3GPP access to immediately establish (or restore) the SNPN PDU session. In addition, in a similar way of establishing the PLMN PDU session with the PLMN 300 using logical non-3GPP access when UE moves from the SNPN 200 to the PLMN 300, and the UE 100 may, on the contrary, establish the SNPN PDU session with the SNPN 200 using the same method described above in a situation where the UE 100 is handed over to the PLMN 300.

In the case of dual radio, after the AMF of the SNPN 200 determines the user plane switching of the UE 100 based on the UE analysis information, the user plane switching may be triggered for the UE 100 through a RAN of the SNPN 200 in step S245′. Subsequently, the UE 100 may perform the user plane switching from the SNPN 200 to the PLMN 300. For example, the UE 100 may register with the PLMN 300 using 3GPP access in step S250 and change a wireless system of the PLMN PDU session from non-3GPP access to 3GPP access in step S255′. By the user plane switching in step S255′, the PLMN PDU session between the UE 100 and the PLMN 300 in the dual radio case may continue through 3GPP access. In addition, in the dual radio case, the PLMN PDU session between the UE 100 and the PLMN 300 may continue by session generation through logical non-3GPP access. In this case, the SNPN PDU session between the UE 100 and the SNPN 200 may not be terminated. In an embodiment, when the connection between the UE 100 and the PLMN 300 is maintained, the SNPN PDU session between the UE 100 and the SNPN 200 may not be terminated using logical non-3GPP access.

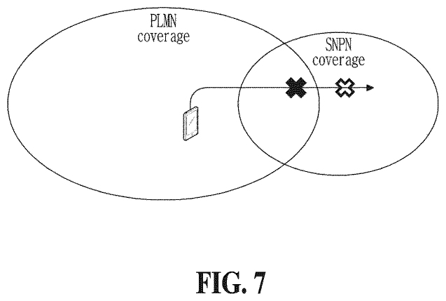

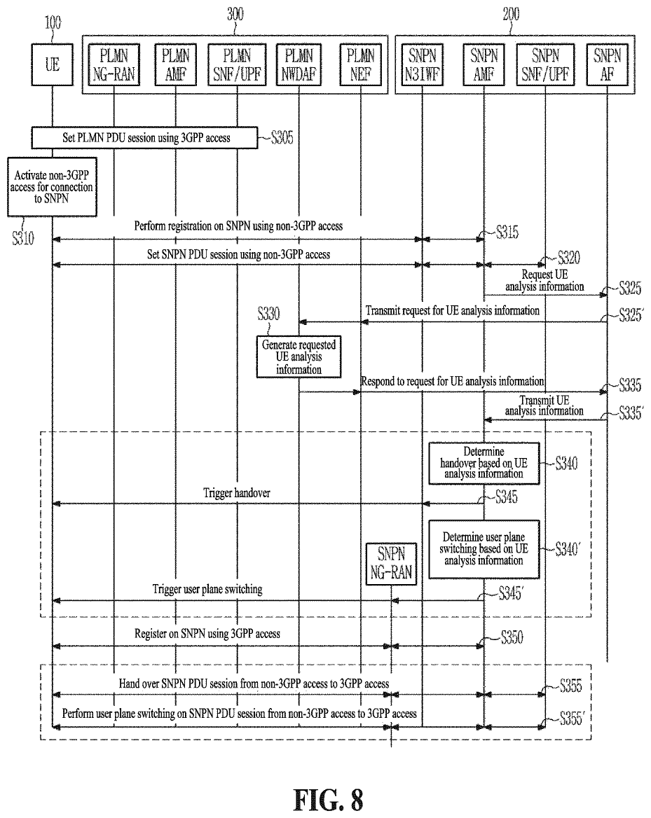

FIG. 7 is a conceptual diagram illustrating a scenario in which UE moves from a PLMN to an SNPN according to an embodiment, and FIG. 8 is a flowchart illustrating a method of supporting service continuity when UE moves from a PLMN to an SNPN according to an embodiment.

According to an embodiment, while receiving a service from the PLMN 300 using 3GPP access, the UE 100 may move the 3GPP access to the SNPN 200 (i.e., single radio) or add the 3GPP access to the SNPN 200 (i.e., dual radio), using non-3GPP access.

Referring to FIG. 7, the coverage of the PLMN 300 and the coverage of the SNPN 200 may form an overlapping area. In an embodiment, the UE 100, which has had 3GPP access to the PLMN 300, may perform the handover or the user plane switching from the PLMN 300 to the SNPN 200 according to an instruction of the AMF of the SNPN 200 before departing from the coverage of the PLMN 300. The AMF of the SNPN 200 may transmit a trigger for the handover or the user plane switching to the UE 100 based on the UE analysis information generated by the NWDAF of the PLMN 300.

Referring to FIG. 8, the UE 100 may establish a PDU session with the PLMN 300 (i.e., a PLMN PDU session) using 3GPP access in step S305. Subsequently, the UE 100 may activate non-3GPP access for connection to the SNPN 200 in step S310. The UE 100 may activate non-3GPP access to connect to the SNPN 200 according to a determination of the UE 100 itself or an instruction from another entity (e.g., the AMF of the PLMN 300, etc.).

The AMF of the PLMN 300 may generate activation signaling using a location of the UE 100, a network deployment, an SLA, or the like, and instruct the UE 100 to activate non-3GPP access using the activation signaling. The activation signaling may include action information of the UE 100 for the connection to the SNPN 200, and the action information may include parameters related to registration, PDU session establishment, a target network identifier, an access type, an SSC mode, and an area where the UE 100 is located (e.g., an applicable area for UE action). The UE 100 that has activated the non-3GPP access may perform registration on the SNPN 200 through the N3IWF of the SNPN 200 using non-3GPP access in step S315. The UE 100 may determine whether to perform the registration on the SNPN 200 using the activation signaling and related information (e.g., subscription information of the UE 100, location information of the UE 100, etc.). Subsequently, the UE 100 may establish a PDU session with the SNPN 200 (i.e., an SNPN PDU session) through the N3IWF of the SNPN 200 using non-3GPP access in step S320.

When the UE 100 performs the registration on the SNPN 200 and/or establishes the SNPN PDU session, the AMF of the SNPN 200 may request the NWDAF of the PLMN 300 for UE analysis information of the UE 100 to trigger a handover (i.e., single radio) of the UE 100 or trigger user plane switching (i.e., dual radio) in step S325. The NWDAF of the PLMN 300 may identify a UE for which generation of UE analysis information is required from the request for the UE analysis information and may generate UE analysis information of the identified UE in step S330. Subsequently, the NWDAF of the PLMN 300 may transmit the generated UE analysis information to the AMF of the SNPN 200 in step S335.

When there is a UE registered with the SNPN 200 through non-3GPP access or when there is a UE that has established the SNPN PDU session through non-3GPP access, the AMF of the SNPN 200 may request the NWDAF of the PLMN 300 for UE analysis information of the UE. The AMF of the SNPN 200 may request the NWDAF of the PLMN 300 for the UE analysis information using an identifier (e.g., SUPI, SUCI, IMSI, IMEI, etc.) of the UE that has established the SNPN PDU session.

The UE analysis information may include at least one of UE mobility analytics, UE communication analytics, UE location-related prediction information/statistic information, or UE mobility predictions/UE mobility statistics. The UE location-related prediction information may be, for example, UE location information (e.g., a cell identifier, a TAI, a TAC, etc.) of the UE 100 associated with a location where the UE 100 is expected to be present after several time durations or time slots in the future.

The request for the UE analysis information, which is transmitted by the AMF of the SNPN 200, may be relayed by an AF of the SNPN 200 and an NEF of the PLMN 300. For example, the AF of the SNPN 200 may transmit the request for the UE analysis information about the UE 100 to the NEF of the PLMN 300 that is connected to the UE 100 through 3GPP access.

The NEF of the PLMN 300 may receive the UE analysis information from the NWDAF of the PLMN 300 and transmit the UE analysis information to the AF of the SNPN 200. After receiving the UE analysis information from the AF of the SNPN 200, the AMF of the SNPN 200 may determine a handover of the UE 100 in step S340 or determine user plane switching in step S340′, based on the UE analysis information generated by the NWDAF of the PLMN 300.

The AMF of the SNPN 200 may predict that the UE 100 is to move from the PLMN 300 to the SNPN 200 based on the analysis information before the UE 100 departs from the coverage of the PLMN 300 and may then determine the handover or the user plane switching of the UE 100 based on the prediction. Alternatively, the AMF of the SNPN 200 may predict that the UE 100 is to move from the PLMN 300 to the SNPN 200 based on the analysis information before the UE 100 recognizes a coverage loss from the PLMN 300 and may then determine the handover or the user plane switching of the UE 100 based on the prediction.

In the case of single radio, after the AMF of the SNPN 200 determines the handover of the UE 100 based on the UE analysis information, the handover may be triggered for the UE 100 through the N3IWF of the SNPN 200 in step S345. Subsequently, the UE 100 may perform the handover from the PLMN 300 to the SNPN 200. For example, the UE 100 may register with the SNPN 200 using 3GPP access in step S350 and change a wireless system of the SNPN PDU session from non-3GPP access to 3GPP access in step S355. By the handover in step S355, the PLMN PDU session between the UE 100 and the PLMN 300 in the single radio case may be terminated, and the SNPN PDU session between the UE 100 and the SNPN 200 may continue through 3GPP access.

In the case of dual radio, after determining the user plane switching of the UE 100 based on the UE analysis information, the AMF of the SNPN 200 may trigger the user plane switching for the UE 100 through the NG-RAN of the SNPN 200 in step S345′. Subsequently, the UE 100 may perform the user plane switching from the PLMN 300 to the SNPN 200. For example, the UE 100 may register with the SNPN 200 using 3GPP access in step S350 and perform the user plane switching on the SNPN PDU session from non-3GPP access to 3GPP access in step S355′. By the user plane switching in step S355′, the SNPN PDU session between UE 100 and SNPN 200 in the dual radio case may continue through 3GPP access. In this case, the PLMN PDU session between the UE 100 and the PLMN 300 may not be terminated.

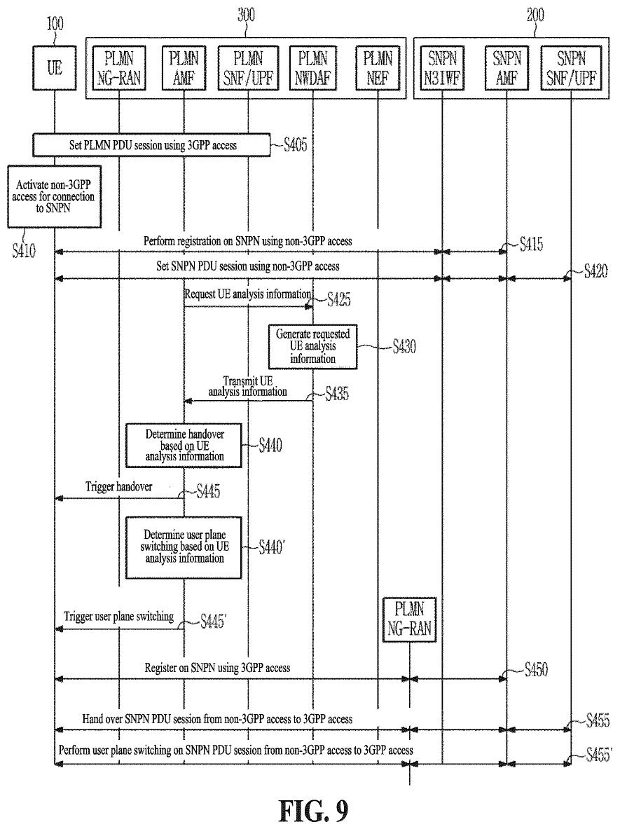

FIG. 9 is a flowchart illustrating a method of supporting service continuity when UE moves from a PLMN to an SNPN according to another embodiment.

Referring to FIG. 9, the UE 100 may establish a PDU session with the PLMN 300 (i.e., a PLMN PDU session) using 3GPP access in step S405. Subsequently, the UE 100 may activate non-3GPP access for connection to the SNPN 200 in step S410. The UE 100 may activate non-3GPP access to connect to the SNPN 200 according to a determination of the UE 100 itself or an instruction from another entity (e.g., the AMF of the PLMN 300, etc.).

The AMF of the PLMN 300 may generate activation signaling using a location of the UE 100, a network deployment, an SLA, or the like, and instruct the UE 100 to activate non-3GPP access using the activation signaling. The activation signaling may include action information of the UE 100 for the connection to the SNPN 200, and the action information may include parameters related to registration, PDU session establishment, a target network identifier, an access type, an SSC mode, and an area where the UE 100 is located (e.g., an applicable area for UE action).

The UE 100 that has activated non-3GPP access may perform registration on the SNPN 200 through the N3IWF of the SNPN 200 using non-3GPP access in step S415. Before performing the registration, the UE 100 may determine whether to perform the registration on the SNPN 200 using the activation signaling and related information (e.g., subscription information of the UE 100, location information of the UE 100, etc.). Subsequently, the UE 100 may establish an SNPN PDU session with the SNPN 200 through the N3IWF of the SNPN 200 using non-3GPP access in step S420.

When the UE 100 activates non-3GPP access for the connection to the SNPN 200, the AMF of the PLMN 300 may request the NWDAF of the PLMN 300 for UE analysis information of the UE 100 to trigger a handover of the UE 100 (i.e., single radio) or user plane switching (i.e., dual radio) in step S425. The UE analysis information requested by the AMF of the PLMN 300 may be generated by the NWDAF of the PLMN 300 in step S430 and may then be transmitted to the AMF of the PLMN 300 in step S435.

The PLMN 300 may request the NWDAF of the PLMN 300 for the UE analysis information, using an identifier (e.g., SUPI, SUCI, IMSI, IMEI, GUTI, etc.) of a UE that has activated non-3GPP access.

The UE analysis information may include at least one of UE mobility analytics, UE communication analytics, UE location-related prediction information/statistic information, or UE mobility predictions/UE mobility statistics. The UE location/mobility-related prediction information may be, for example, UE location information (e.g., a cell identifier, a TAI, a TAC, etc.) of the UE 100 associated with a location where the UE 100 is expected to be present after several time durations or time slots in the future.

The AMF of the PLMN 300 may determine the handover of the UE 100 in step S440 or determine the user plane switching in step S440′, based on the UE analysis information generated by the NWDAF of the PLMN 300. The AMF of the PLMN 300 may predict that the UE 100 is to move from the PLMN 300 to the SNPN 200 based on the analysis information before the UE 100 departs from the coverage of the PLMN 300 and may then determine the handover of the UE 100 or the user plane switching based on the prediction. Alternatively, the AMF of the PLMN 300 may predict that the UE 100 is to move from the PLMN 300 to the SNPN 200 based on the analysis information before the UE 100 recognizes a coverage loss from the PLMN 300 and may then determine the handover of the UE 100 or the user plane switching based on the prediction.

In the case of single radio, after the AMF of the PLMN 300 determines the handover of the UE 100 based on the UE analysis information, the handover may be triggered for the UE 100 through the RAN of the PLMN 300 in step S445. Subsequently, the UE 100 may perform the handover from the PLMN 300 to the SNPN 200. For example, the UE 100 may register with the SNPN 200 using 3GPP access in step S450 and change a wireless system of the SNPN PDU session from non-3GPP access to 3GPP access in step S455. By the handover in step S455, in the single radio case, the PLMN PDU session between the UE 100 and the PLMN 300 may be terminated, and the SNPN PDU session between the UE 100 and the SNPN 200 may continue through 3GPP access.

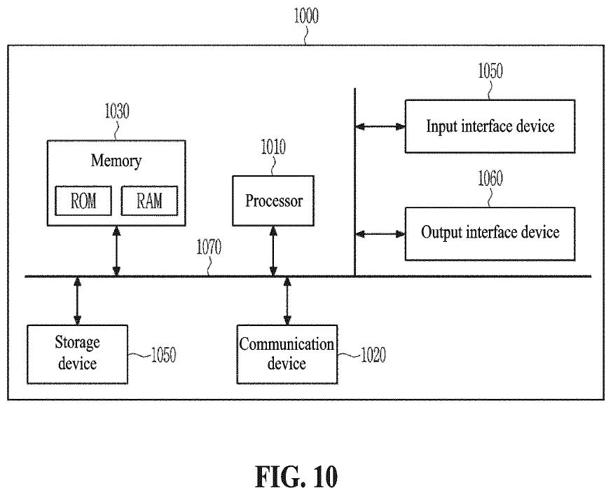

In the case of dual radio, after the AMF of the PLMN 300 determines the user plane switching of the UE 100 based on the UE analysis information, the user plane switching may be triggered for the UE 100 through the RAN of the PLMN 300 in step S445′. Subsequently, the UE 100 may perform the user plane switching from the PLMN 300 to the SNPN 200. For example, the UE 100 may register with the SNPN 200 using 3GPP access in step S450 and change a wireless system of the SNPN PDU session from non-3GPP access to 3GPP access in step S455′. By the user plane switching in step S455′, in the dual radio case, the SNPN PDU session between the UE 100 and the SNPN 200 may continue through 3GPP access. In this case, the PLMN PDU session between the UE 100 and the PLMN 300 may not be terminated. FIG. 10 is a block diagram illustrating a wireless communication system according to an embodiment.

According to an embodiment, a network device may be the RAN, the AMF, the SMF, or the NWDAF described above, and may be implemented as a computer system, for example, a computer-readable medium. Referring to FIG. 10, a computer system 700 may include at least one of a processor 710, a memory 730, an input interface device 750, an output interface device 760, and a storage device 740, which may communicate through a bus 770. The computer system 700 may also include a communication device 720 connected to a network. The processor 710 may be a central processing unit (CPU) or a semiconductor device that executes instructions stored in the memory 730 or the storage device 740. The memory 730 and the storage device 740 may include various types of volatile or non-volatile storage media. For example, memory described herein may include read-only memory (ROM) and random-access memory (RAM). In the embodiments of the present disclosure, the memory may be located inside or outside a processor, and the memory may be connected to the processor through various known means. The memory may be volatile or non-volatile storage media of various types, for example, ROM or RAM.

Accordingly, the embodiments of the present disclosure may be implemented as a computer-implemented method or as a non-transitory computer-readable medium having computer-executable instructions stored thereon. In an embodiment, when executed by a processor, computer-readable instructions may cause the processor to perform a method according to at least one embodiment of the present disclosure. The communication device 720 may transmit or receive wired signals or wireless signals.

The embodiments may not be implemented only by the method(s) and/or apparatus described herein but may be implemented by programs or recording media including the program that executes functions according to the embodiments. The embodiments may be implemented easily by a person having ordinary skill in the art to which the present disclosure pertains from the description of the embodiments. Specifically, the methods (e.g., a network management method, a data transfer method, a transmission schedule generation method, etc.) according to the embodiments may be implemented in various forms of program instructions to be performed by various computer means and may be recorded in non-transitory computer-readable media. The media may also include, alone or in combination with the program instructions, data files, data structures, or the like. The program instructions recorded on the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), or the like. Examples of program instructions include both machine code, such as produced by a compiler, and files containing higher-level code that may be executed by the computer using an interpreter.

While the present disclosure includes specific examples, it will be apparent to one of ordinary skill in the art that various changes in form and details may be made in these examples without departing from the spirit and scope of the claims and their equivalents. Therefore, the scope of the present disclosure is defined not by the detailed description, but by the claims and their equivalents, and all variations within the scope of the claims and their equivalents are to be construed as being included in the disclosure.

1. A method of supporting service continuity of user equipment (UE) moving from a stand-alone non-public network (SNPN) to a public land mobile network (PLMN), the method comprising:
receiving, from a 5G network data analytics function (NWDAF) of the SNPN, analysis information about UE that has established a PLMN protocol data unit (PDU) session with the PLMN using non-3GPP access;
determining that the UE is to move from the SNPN to the PLMN based on the analysis information; and
instructing the UE to change access for the PLMN PDU session from the non-3GPP access to 3GPP access based on the determining.

2. The method of claim 1, wherein the determining that the UE is to move from the SNPN to the PLMN based on the analysis information comprises:
predicting that the UE is to move from the SNPN to the PLMN based on the analysis information before the UE departs from a coverage of the SNPN.

3. The method of claim 1, wherein the determining that the UE is to move from the SNPN to the PLMN based on the analysis information comprises:
predicting that the UE is to move from the SNPN to the PLMN based on the analysis information before the UE recognizes a coverage loss from the SNPN.

4. The method of claim 1, wherein the analysis information comprises UE mobility predictions related to mobility of the UE and/or UE mobility statistics related to the mobility of the UE.

5. The method of claim 1, wherein the instructing the UE to change access for the PLMN PDU session from the non-3GPP access to the 3GPP access based on the determining comprises:
instructing the UE on a handover from the SNPN to the PLMN based on the determining.

6. The method of claim 1, wherein the instructing the UE to change access for the PLMN PDU session from the non-3GPP access to the 3GPP access based on the determining comprises:
instructing the UE to switch a user plane resource for the PLMN PDU session from the non-3GPP access to the 3GPP access based on the determining.

7. The method of claim 1, wherein the receiving the analysis information about the UE that has established the PLMN PDU session with the PLMN using the non-3GPP access from the NWDAF of the SNPN comprises:
transmitting a request for the analysis information to a network exposure function (NEF) of the SNPN through an application function (AF) of the PLMN.

8. The method of claim 1, wherein, before the receiving the analysis information about the UE that has established the PLMN PDU session with the PLMN using the non-3GPP access from the NWDAF of the SNPN,
an SNPN PDU session using the 3GPP access is established between the UE and the SNPN, and the PLMN PDU session using the non-3GPP access is established between the UE and the PLMN.

9. A method of supporting service continuity of user equipment (UE) moving from a public land mobile network (PLMN) to a stand-alone non-public network (SNPN), the method comprising:
receiving, from a 5G network data analytics function (NWDAF) of the PLMN, analysis information about UE that has established an SNPN protocol data unit (PDU) session with the SNPN using non-3GPP access;
determining that the UE is to move from the PLMN to the SNPN based on the analysis information; and
instructing the UE to change access for the SNPN PDU session from the non-3GPP access to 3GPP access based on the determining.

10. The method of claim 9, wherein the determining that the UE is to move from the PLMN to the SNPN based on the analysis information comprises:
predicting that the UE is to move from the PLMN to the SNPN based on the analysis information before the UE departs from a coverage of the PLMN.

11. The method of claim 8, wherein the determining that the UE is to move from the PLMN to the SNPN based on the analysis information comprises:
predicting that the UE is to move from the PLMN to the SNPN based on the analysis information before the UE recognizes a coverage loss from the PLMN.

12. The method of claim 9, wherein the analysis information comprises UE mobility predictions related to mobility of the UE and/or UE mobility statistics related to the mobility of the UE.

13. The method of claim 9, wherein the instructing the UE to change access for the SNPN PDU session from the non-3GPP access to the 3GPP access based on the determining comprises:
instructing the UE on a handover from the PLMN to the SNPN based on the determining.

14. The method of claim 9, wherein the instructing the UE to change access for the SNPN PDU session from the non-3GPP access to the 3GPP access based on the determining comprises:
instructing the UE to switch a user plane resource for the SNPN PDU session from the non-3GPP access to the 3GPP access based on the determining.

15. The method of claim 9, wherein the receiving the analysis information about the UE that has established the SNPN PDU session with the SNPN from the NWDAF of the PLMN using the non-3GPP access comprises:
transmitting a request for the analysis information to a network exposure function (NEF) of the PLMN through an application function (AF) of the SNPN.

16. The method of claim 9, wherein, before receiving the analysis information about the UE that has established the SNPN PDU session with the SNPN using the non-3GPP access from the NWDAF of the PLMN,
a PLMN PDU session using the 3GPP access is established between the UE and the PLMN, and the SNPN PDU session using the non-3GPP access is established between the UE and the SNPN.
